(19) United States
(12) Patent Application Publication
(10) Pub. No.: US 2022/0272394 A1
(43) Pub. Date: Aug. 25, 2022

(54) SYSTEMS AND METHODS FOR IMPROVED ADAPTIVE VIDEO STREAMING

(71) Applicant: Rovi Guides, Inc., San Jose, CA (US)

(72) Inventors: Padmassri Chandrashekar, Bangalore (IN); Daina Emmanuel, Bangalore (IN); Jayshil Parekh, Bengaluru (IN)

(21) Appl. No.: 17/180,170

(22) Filed: Feb. 19, 2021

(51) Int. Cl. H04N 21/2343; H04N 21/81; H04N 21/239; H04N 21/238

(52) U.S. Cl. CPC H04N 21/23439; H04N 21/812; H04N 21/2393; H04N 21/238

(57) ABSTRACT

Systems and methods for improved adaptive video streaming are disclosed. The methods comprise receiving a first request to stream multimedia content stored on the multimedia content storage; streaming a first stream of multimedia content, wherein the first stream of multimedia content is one of the set of alternative variants of the multimedia content; receiving a second request to stream multimedia content stored on the multimedia content storage; and streaming a second stream of multimedia content, wherein the second stream of multimedia content is a different one of the set of alternative variants of the multimedia content, wherein the multimedia content comprises audio, video and advertisement data and each of the audio, video and advertisement data comprises a set of alternative variants.

### BACKGROUND

The present disclosure relates to adaptive video streaming systems and methods and, more particularly, to systems and methods to reduce buffering between video and advertisement content transitions.

### SUMMARY

Adaptive bitrate streaming (also known as adaptive streaming or adaptive video streaming) is a technology designed to deliver video to a user in the most efficient and useable quality possible. Conventional streaming media systems that deliver media assets over a network often use adaptive bitrate algorithms to optimize a balance between providing a user with the highest possible media quality (e.g., bitrate) and minimizing playback stalling (known as buffering). By way of summary, streaming media systems aim to maximize stability by switching bitrates when, for example, the transfer rate is too slow compared to the play speed of the media asset. Most video systems select a bitrate that most closely matches an observed network bandwidth and request an appropriate quality of a next segment of the media asset that the bandwidth can accommodate at that time. In this way, the video system can provide smooth playback and quick start of the media asset.

While in the past most video or audio streaming technologies utilized streaming protocols such as real time transport protocol (RTP) with real time streaming protocol (RTSP), modern adaptive streaming technologies are mostly based on hypertext transfer protocol (HTTP). Current adaptive bitrate streaming solutions, such as MPEG-DASH or Apple HLS, allow a user to select a priority of quality or reduction of buffering when watching a video. In most situations, users prefer to watch a lower-quality portion of a video rather than waiting for a higher-quality portion of the video to be downloaded. In addition, most video platforms that utilize adaptive video streaming technologies also provide advertisements to a user. MPEG-DASH is the only adaptive bitrate HTTP-based streaming solution that is an international standard. However, it does not allow a user to choose a quality of an advertisement to be shown or enable the user to consume the advertisement in a different way, neither does any other adaptive bitrate streaming technology.

Currently, advertisements are presented to the viewer in a number of ways, such as: spaced evenly along the length of a video, for example at 20%, 40%, 60%, and 80% of a video length; at a certain timestamp in the video, for example 30 seconds; or after the user has consumed a certain threshold of non-advertisement content, for example 30 minutes of video content before an advertisement is forced on a user. However, in the previous examples, when providing an advertisement, current systems break the loading of the next segment of the media asset in an adaptive bitrate streaming environment to buffer and play the advertisement. In other words, the advertisement is not a part of the adaptive bitrate stream and is therefore not encoded into the bitrate variants of an adaptive bitrate stream.

In addition, advertisements may also be targeted to a user's interests based on a known profile or historic browsing data of the user. The content creator of a video does not get to create an advertising playlist or data for their videos. For example, popular content creators on platforms such as YouTube often have a paid product placement or a sponsored segment in their videos. The advertisements that the content creators make are not a part of the adaptive bit stream. Instead, they are placed within video itself, interrupting the flow of the video, or as a link in a description of the video, which isn't as engaging as a more complex advertisement. In another example, the sponsored segment may be entirely relevant to the video the content creator is making, but the user would have to leave the video environment to get more information about the product and cannot consume the advertisement at the same time as the video itself.

Lack of management of adaptive bitrate streaming can further contribute to adverse user experience when advertisements are being loaded outside of a master playlist for an adaptive bitrate stream. In some examples, the user may be presented an advertisement that is of too high a quality for the observed network bandwidth, because advertisements are often based on impression metrics rather than available bandwidth. In some situations, the user is therefore unable to progress through the advertisement to continue watching the video. In some examples, the user of a video platform may have an advertisement blocker installed, which prevents the advertisement from being shown to the user. Consequently, for each impression the video platform doesn't provide, revenue is lost. In some examples, the advertisement shown to the user has no relevance to the video the user is watching, leaving the user unengaged by the advertisement and waiting for it to end before they can return to watching the video content.

Adaptive streaming mechanisms, techniques, and systems described herein are introduced to provide a better viewing experience for a user of a video platform that provides audio, video and advertisement content.

In one approach, there is provided a media server comprising multimedia content storage and a processor. The processor is configured to receive a request to stream multimedia content stored on the multimedia content storage, wherein the multimedia content comprises audio, video and advertisement data, and each of the audio, video and advertisement data comprises a set of alternative variants. The processor is also configured to stream a first stream of multimedia content, wherein the first stream of multimedia content is one of the set of alternative variants of the multimedia content. The processor also receives a second request to stream multimedia content stored in the multimedia content storage and subsequently stream a second stream of multimedia content, wherein the second stream of multimedia content is a different one of the set of alternative variants of the multimedia content.

In some embodiments, the request to stream the multimedia content is made by a remote client device or a network device. For example, a remote client device or a network device (e.g., a laptop, PC, smartphone, smart TV or the like) requests the media server to stream the multimedia content.

In some embodiments, the multimedia content is an adaptive bitrate stream compatible with the MPEG-DASH standard, or other implementations such as Apple HLS. In some embodiments, the first stream of multimedia content is encoded at a first maximum bitrate and/or a first resolution. For example, the request may be a request for a next segment of an adaptive bitrate stream, and therefore the first stream of multimedia content is at a first maximum bitrate (or resolution) based on a first network bandwidth. In some examples, the second stream of multimedia content is encoded at a second maximum bitrate and/or a second resolution. For example, the request may be a request for a second segment of an adaptive bitrate stream, and therefore the second stream of multimedia content is at a second maximum bitrate (or resolution) based on a new current network bandwidth, different from the first network bandwidth. The second stream may be a higher bitrate than the first stream, or vice versa, depending on the network bandwidth at a current time of the request. Accordingly, in some embodiments, each of the alternative streams comprises a plurality of bitrate variants.

In some embodiments, the media content is encoded using an adaptive bitrate streaming compatible codec. There are numerous examples of video codecs that are adaptive bitrate streaming compatible (e.g., x264, OpenH264, H.264/MPEG-4 AVC, which are all codecs compatible with the video format H.264). Moreover, there are numerous examples of video formats (e.g., H.264, H.265, VP9, AV1), each of which has numerous examples of video codecs.

In another approach, there is provided a media transmission system comprising a transceiver module that receives a device parameter from a first client device and transmits a media signal to the first client device; a control module, coupled to the transceiver module, adapted to select one of a first mode of operation and a second mode of operation, in response to the device parameter; a media encoder, coupled to the transceiver module and the control module, adapted to encode the media signal based on the device parameter and the mode of operation to include video data, audio data and advertisement data.

In some embodiments, the first client device parameter includes a device network bandwidth. For example, the device network bandwidth influences the choice of which mode of operation the control module chooses. The device network bandwidth then influences how the media encoder encodes the media signal. Therefore, the media transmission system can transmit a media signal to the first client device based on an available network bandwidth.

In some embodiments, the control module chooses the first mode of operation when the network bandwidth corresponds to a first bitrate. In some embodiments, the control module chooses the second mode of operation when the network bandwidth corresponds to a second bitrate, higher than the first bitrate. For example, at a relatively higher network bandwidth, compared to a first network bandwidth, the control module can increase the bitrate by choosing a second mode of operation, which causes the media encoder to encode a higher bitrate. However, the media encoder is encoding based on the device parameter, which may include a maximum bitrate of the device network. Therefore, a maximum bitrate is provided, which is then increased when the device network increases.

In some embodiments, the independent advertisement data is transmitted to a second client device. In some examples, the independent advertisement data is transmitted to the second client device by the transceiver module or, alternatively, by the first client device. This enables a user of the first client device to independently consume the video and audio data from the advertisement data, on a second device. In some embodiments, the second client device consumes the advertisement data concurrently with the first client device consuming at least one of the audio data or video data. For example, a user of the first client device can consume the advertisement data on a second device without interrupting their consumption of the audio or video data.

In another approach, there is provided a method of streaming adaptive video content. The method comprises receiving a first request to stream multimedia content stored on a multimedia content storage, wherein the multimedia content comprises audio, video and advertisement data and each of the audio, video and advertisement data comprises a set of alternative variants. The method further comprises streaming a first stream of multimedia content, wherein the first stream of multimedia content is one of the set of alternative variants of the multimedia content. In addition, the method comprises receiving a second request to stream multimedia content stored on the multimedia content storage, and streaming a second stream of multimedia content, wherein the second stream of multimedia content is a different one of the set of alternative variants of the multimedia content.

In another approach, there is provided a system comprising means for receiving a first request to stream multimedia content stored on the multimedia content storage, wherein the multimedia content comprises audio, video and advertisement data and each of the audio, video and advertisement data comprises a set of alternative variants. The system further comprising means for streaming a first stream of multimedia content, wherein the first stream of multimedia content is one of the set of alternative variants of the multimedia content; means for receiving a second request to stream multimedia content stored on the multimedia content storage; and means for streaming a second stream of multimedia content, wherein the second stream of multimedia content is a different one of the set of alternative variants of the multimedia content.

In another approach, there is provided a non-transitory, computer-readable medium having instructions encoded thereon for carrying out the methods as described herein.

In another approach, there is provided a system comprising control circuitry configured to execute the methods as described herein.

Advantages of the present disclosure allow for a user to view the advertisements on a secondary device, view the advertisement in the same screen as a video of interest in a picture-in-picture format, consume advertisement data relevant to the video content and/or reduce the inefficiencies of providing an advertisement to a user.

### BRIEF DESCRIPTION OF THE DRAWINGS

The above and other objects and advantages of the disclosures will be apparent upon consideration of the following detailed description, taken in conjunction with the accompanying drawings, in which:

FIG. 1 illustrates an exemplary media server, in accordance with some embodiments of the disclosure.

FIG. 2 illustrates an exemplary master playlist, in accordance with some embodiments of the disclosure.

FIG. 3 is a flowchart of illustrative steps involved in providing an adaptive bitrate stream, in accordance with some embodiments of the disclosure.

FIG. 4 is a flowchart of illustrative steps involved in providing an adaptive bitrate stream comprising alternative variants of multimedia content, in accordance with some embodiments of the disclosure.

FIG. 5 illustrates an exemplary media transmission system that communicates with a remote client device, in accordance with some embodiments of the disclosure.

FIG. 6 is a block diagram representing devices, components of each device, and data flow therebetween for an adaptive video streaming system, in accordance with some embodiments of the disclosure.

### DETAILED DESCRIPTION

Methods and systems are provided herein for adaptive bitrate streaming comprising advertisements.

As described above, adaptive streaming is fast becoming the most widely used method for video delivery to end users over the internet. The ITU-T P.1203 standard is the first standardized quality of experience model for audio visual HTTP-based adaptive streaming. The present disclosure provides an extension for the existing standardized video quality model as well as new formats, i.e., H.265, VP9 and AV1 and resolutions larger than full-HD (e.g., UHD-1). The main criterion for the development of better-quality monitoring and adaptation algorithms is to reduce the overall required bandwidth while not having any perceivable impact on the video and audio quality. However, the current state of the art of delivering advertisements is to interleave the advertisements within a video. Often there is a defined slot for delivering the advertisements, which breaks the loading of a next segment of the adaptive video stream.

More specifically, adaptive bitrate streaming is a method of video streaming over HTTP where the source content is encoded at multiple bit rates. Each of the different bit rate streams is segmented into small multi-second parts. The segment size can vary depending on the particular implementation, but they are typically between two and ten seconds. First, the client downloads a manifest file that describes the available stream segments and their respective bit rates. During stream start-up, the client usually requests the segments from the lowest bit rate stream. If the client finds that the network throughput is greater than the bit rate of the downloaded segment, then it will request a higher bit rate segment. Later, if the client finds that the network throughput has deteriorated, it will request a lower bit rate segment. An adaptive bitrate algorithm in the client performs the key function of deciding which bit rate segments to download, based on the current state of the network.

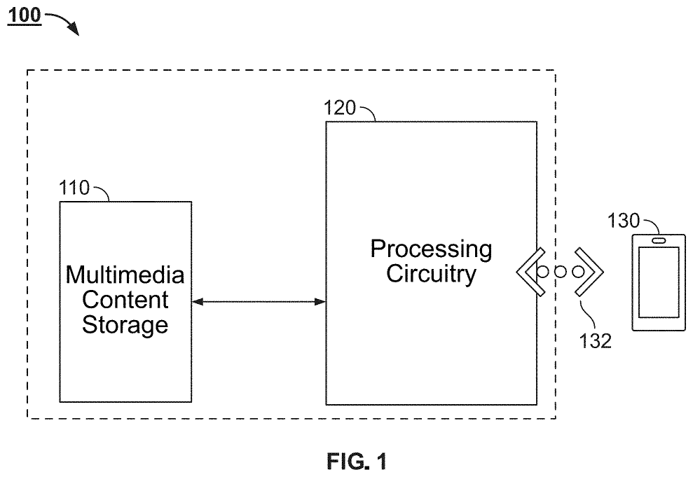

FIG. 1 depicts an exemplary media server 100 comprising a multimedia content storage 110 and processing circuitry 120, which is shown to be connected to a network device 130 via communication link 132. In some examples and as shown in FIG. 1, the multimedia content storage 110 is coupled to the processing circuitry 120. The processing circuitry 120 is configured to receive a first request to stream multimedia content stored on the multimedia content storage 110. The multimedia content may be thought of as the source content to be encoded at multiple bit rates for an adaptive video stream. In particular, the multimedia content comprises audio, video, and advertisement data.

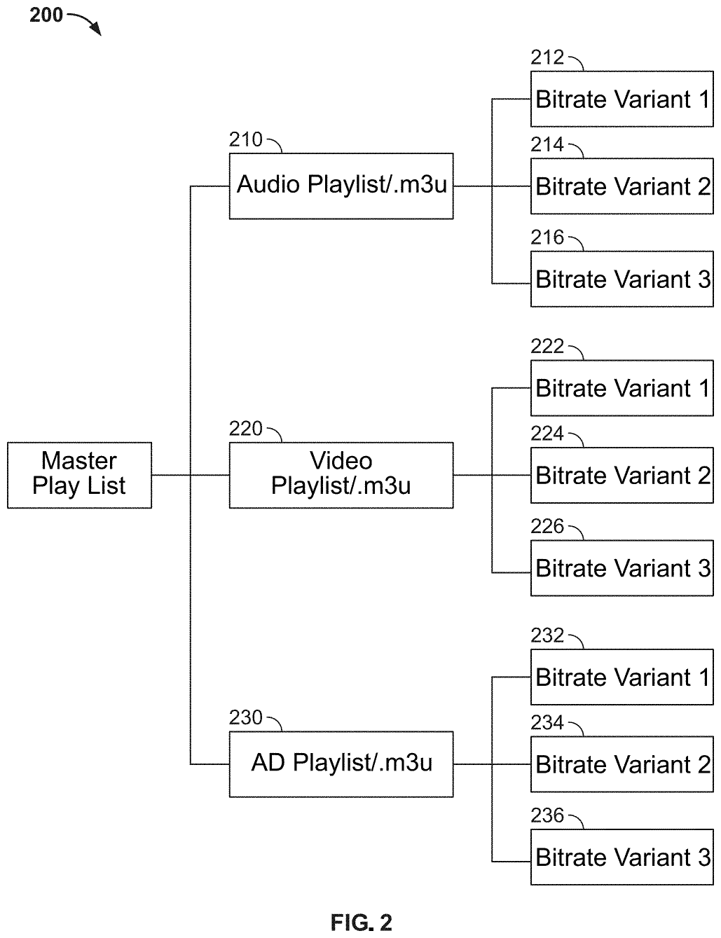

Generally, advertisement data segments, frames or groups of frames are signalled in parallel with audio and video data. In other words, an additional added track, playlist or data, containing advertisements may be added to the adaptive video stream alongside the audio and video data. Each of the audio, video and advertisement data comprise a set of alternative variants. Therefore, as the advertisement data is provided as a separate stream segment, the network device 130 requests the advertisement data alongside the audio and video data in a similar manner to that described in the MPEG-DASH specification (i.e., requesting a bitrate variant of the media signal based on a current network bandwidth). A more detailed description of a master playlist comprising audio, video and advertisement data is provided with reference to FIG. 2 below.

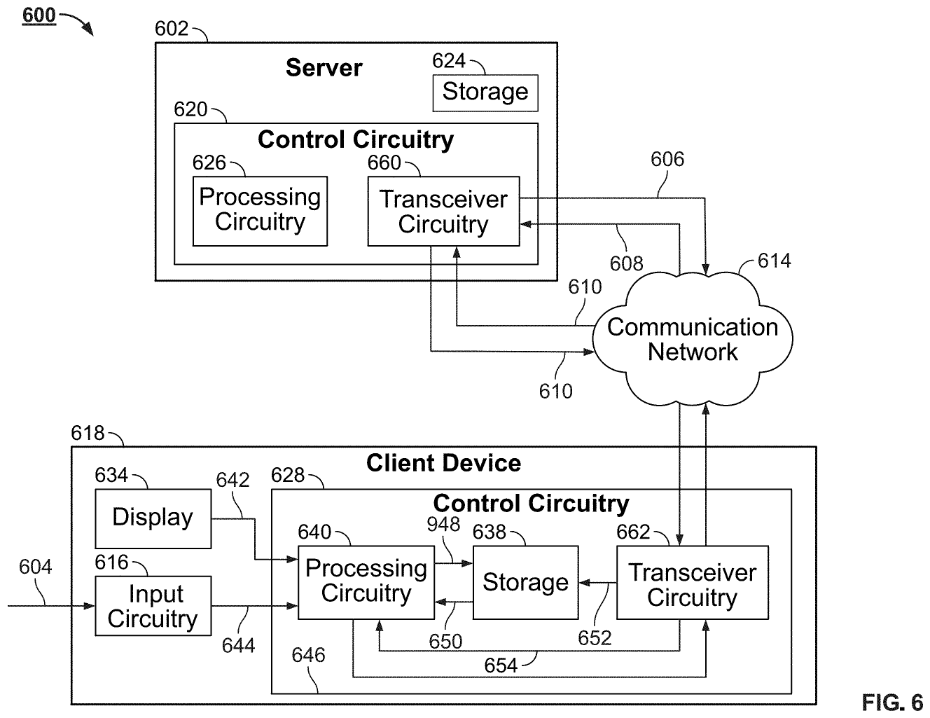

The processing circuitry 120 may comprise a plurality of processing elements, as is described in more detail with reference to FIG. 6, such as a processor or number of processors. In some examples, the processing circuitry 120 is further configured to stream a first stream of the requested multimedia content stored on the multimedia content storage 110. The first stream of the multimedia content comprises a first set of alternative variants, or bitrates, of the audio, video and advertisement data. In some examples, the first set of alternative variants is chosen based on a bandwidth of the network device 130 indicated in the first request from the network device 130 to the processing circuitry 120.

The processing circuitry 120 is further configured to receive a second request to stream the multimedia content on the multimedia content storage 110. The processing circuitry 120 is configured to stream a second stream of multimedia content, wherein the second stream of multimedia content comprises a second set of alternative variants of the audio, video and advertisement data. In some examples, the second set of alternative variants is chosen based on a bandwidth of the network device 130 indicated in the second request.

Media server 100 may further comprise an encoder (not shown). In some examples, the encoder is located within the processing circuitry 120. In other examples, the encoder is located externally to the processing circuitry 120. The processing circuitry 120 may therefore be further configured to encode the first and second streams of multimedia content. The encoder may be further configured to encode the stream at a maximum bitrate or a best resolution possible, based on the available bandwidth of the network device 130.

The media server 100 may further comprise network circuitry (not shown). In some examples, the network circuitry is located within the processing circuitry 120. In other examples, the network circuitry is located externally to the processing circuitry 120. The processing circuitry 120 may therefore be further configured to communicate with the network device 130 via communication link 132. The means of communication between the network device 130 and the processing circuitry 120 is described in more detail with reference to FIG. 6.

FIG. 2 depicts an exemplary master playlist 200, which comprises an audio playlist 210, video playlist 220, and advertisement playlist 230, wherein each of the audio, video and advertisement playlists comprises bitrate variants 212-216, 222-226 and 232-236, respectively. For example, the audio playlist 210 comprises bitrate variants 212, 214 and 216. In some examples, bitrate variant 212 is the highest bitrate variant of the audio playlist 210 and bitrate variant 216 is the lowest bitrate variant of the audio playlist 210. The number of bitrate variants shown is for illustrative purposes only, and there may be one or more bitrate variants for each of the audio 210, video 220 and advertisement 230 playlists.

The bitrate variants 212-216, 222-226, and 232-236 are encoded with resolutions ranging from, for example, 360p to 2160p and various quality levels using adaptive bitrate streaming compatible codecs and resolutions for adaptive video streaming formats. In some examples, the lowest bitrate variants are text, hyperlinked text or a still image. For example, a video regarding a certain news story may have a corresponding advertisement playlist, with a low bitrate variant, such as static images from a local news source. Each of the bitrate variants is separated by a minimum delta megabit per second (Mbps), for example 1 Mbps or 2 Mbps.

In some examples, the master playlist 200 is transmitted as a manifest that describes the available stream segments of an adaptive video stream and their respective bitrate variants to the network device 130. In some examples, the advertisement data playlist 230 can be consumed on a first device independently of the audio 210 and video 220 playlists.

Therefore, although the master playlist is transmitted with each of the audio 210, video 220 and advertisement 230 playlists, a user of the network device 130 can consume the data in several different ways. For example, the advertisement playlist 230 can be a next segment of a plurality of segments of an adaptive bitrate stream (e.g., MPEG-DASH, Adobe HTTP Dynamic Streaming, Apple HTTP Live Streaming, Microsoft Smooth Streaming, QuavStreams Adaptive Streaming over HTTP, upLynk or the like). In some examples, the advertisement data within the advertisement playlist 230 is consumed on the network device 130 at the same time as the audio data and the video data within the audio playlist 210 and video playlist 220. For example, the audio, video and advertisement data is contained within a segment of a plurality of segments of an adaptive bitrate stream, and the advertisement data could be consumed as a picture-in-picture view of the adaptive bitrate stream. In this way, the user can consume the audio and video data with the advertisement data concurrently, on the same device or screen. In some examples, the user can toggle between the audio and video data on the first device and the advertisement data.

In some examples, the master playlist 200 is also transmitted to a second network device (not shown). This enables a user of the first network device 130 and second network device to consume the audio and video data on the first device and consume the advertisement data on a second device. In this way, the user can maintain an uninterrupted viewing experience of the audio and video data on the first device, while consuming the advertisement data on the second device. In some examples, the advertisement data is consumed on the second client device, and the audio and video data is consumed on the first device concurrently.

On some video platforms, consuming advertisement data is mandated based on time stamps of video data, or after consuming a certain amount of video data, as described in the summary section above. In combination with the current disclosure, in some examples, the user would be able to consume the mandated advertisement data in a way that they desire, or a way that provides them with their subjective optimal viewing experience. For example, rather than interrupting the audio and video data being consumed on the first device to view an advertisement, the user can consume the advertisement data as a picture-in-picture with the audio and video data, on a second device, or by toggling between advertisement and video data at their leisure. In this way, the user has a better viewing experience of the audio and video data, which is no longer interrupted at a time mandated by the video platform.

In some examples, the audio, video or advertisement data described in the playlists 210, 220 and 230 has a magnitude of size from bits to megabits or larger. Therefore, in some examples, based on the available bandwidth, the bitrate variants of the audio playlist 210, video playlist 220 and advertisement playlist 230 are intelligently chosen to maximize the available bandwidth of the client device. For example, for a podcast, the video data may have a lower priority than the audio data. However, audio data typically consumes much less of the bandwidth available at the client device. Therefore, an advertisement bitrate variant can be chosen from the advertisement playlist 230 that maximizes the available remaining bandwidth at the client device. Similarly, the video data within the video playlist 220 may be a higher priority than the audio data within the audio playlist 210, such as an IP camera feed, which typically has no audio data.

Therefore, in some examples, based on the content of the audio and video data, the advertisement bitrate variants 232-236 are chosen to take up more or less of the available bandwidth of the client device. In another example, a video about a holiday would have an advertisement data stream comprising images for a hotel or flights relevant to the holiday, which would not require more than a few bits to megabits per second of bandwidth. In this way, the bitrate variant of the advertisement data stream can be chosen to ensure maximum quality of the audio and video data, and vice versa, whichever is be more appropriate based on the content of the audio and video data.

The advertisement playlist 230 may be created at the same time as the audio playlist 210 and video playlist 220, or the advertisement playlist 230 may be created after and added to the master playlist 200 at a later time. For example, a video platform provider can add the advertisement playlist 230 to the master playlist 200 of content already hosted on the platform, known as legacy content. In other words, the master playlist 200 or manifest of legacy content can be regenerated with the advertisement playlist 230 added.

Moreover, the advertisement playlist 230 may be created by the content creator of the audio and video data. For example, if the content creator has created the video in partnership with a sponsor, certain video segments of the video data as described on the video playlist 220 may comprise products to be specifically advertised in the advertisement data, as described by the advertisement playlist 230.

In some examples, the master playlist 200, comprising the audio playlist 210, video playlist 220 and advertisement playlist 230, is compatible with legacy media players are that not specifically adapted to receive the advertisement playlist 230. For example, the advertisement playlist 230 may comprise an identifier, which would cause a legacy media player not to fetch the segments for the advertisement data as a part of the adaptive video stream and the master playlist 200 would still be able to provide the audio and video data.

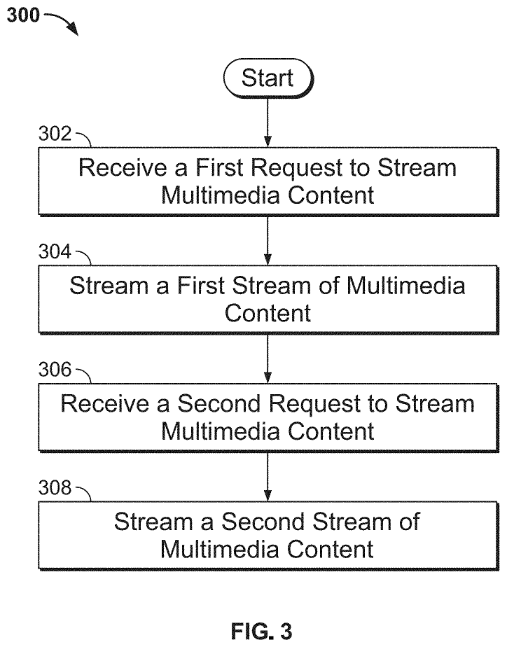

FIG. 3 is a flowchart of illustrative steps involved in providing an adaptive bitrate stream. While playing back streamed video data, client devices, such as network client 130, often switch between video streams based on network conditions in order to ensure smooth video playback. A process 300 for streaming multimedia content to a client device, for use in adaptive streaming systems in accordance with an embodiment of the disclosure, is illustrated in FIG. 3. The process 300 begins at step 302 wherein a first request to stream multimedia content is received. In some examples, the request is received from a first client device, such as that described with regard to FIGS. 1, 5 and 6. In some examples, the request also comprises a first network bandwidth of the first client device at the time of the first request.

At step 304, a first stream of multimedia content is streamed. In some examples, the first stream of multimedia content is encoded at a first maximum bitrate and/or a first resolution. For example, the request may be a request for a next segment of an adaptive bitrate stream, and therefore the first stream of multimedia content is at a first maximum bitrate (or resolution) based on a first network bandwidth.

At step 306, a second request to stream multimedia content is received. For example, the request may be a request for a second segment of an adaptive bitrate stream. The second request to stream multimedia content may also comprise a second network bandwidth of the client device at the time of the second request, different from the first network bandwidth of the client device.

At step 308, a second stream of multimedia content is streamed. In some examples, the second stream of multimedia content is encoded at a second maximum bitrate and/or a second resolution. The second stream may therefore be a higher bitrate than the first stream, or vice versa, depending on the network bandwidth at the time of the second request.

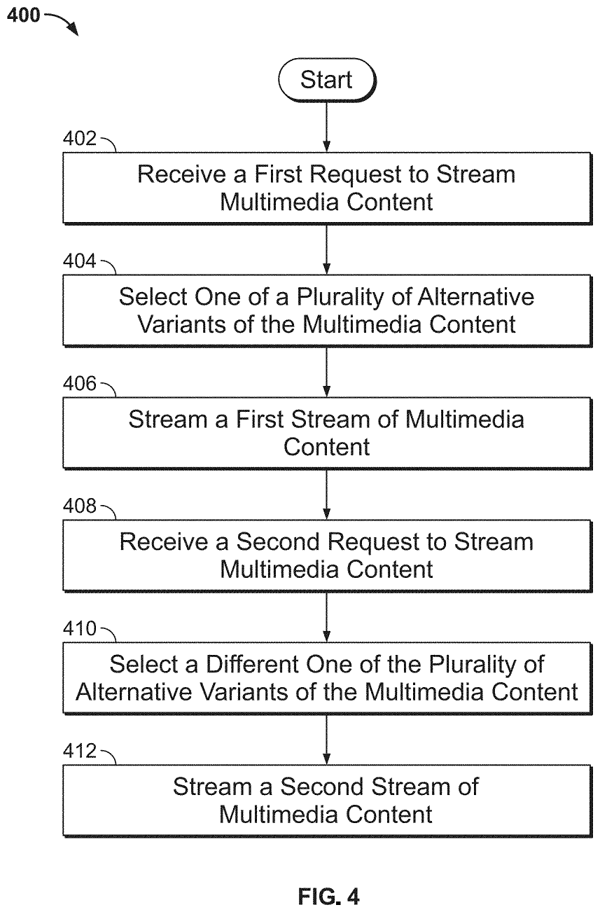

FIG. 4 is a flowchart of illustrative steps involved in providing an adaptive bitrate stream comprising alternative variants of multimedia content. While provisioning a request to stream multimedia content, a master playlist 200, such as that described with reference to FIG. 2, comprises an audio playlist 210, video playlist 220, and an advertisement playlist 230, each with a plurality of alternative variants of the multimedia content. A process 400 for streaming multimedia content to a client device, for use in adaptive streaming systems in accordance with an embodiment of the invention, is illustrated in FIG. 4. The process 400 begins at step 402 wherein a first request to stream multimedia content is received. In some examples, the request is received from a first client device, such as that described regarding FIGS. 1, 5 and 6.

At step 404, one of a plurality of alternative variants of the multimedia content is selected. The plurality of alternative variants may be the bitrate variants 212-216, 222-226, 232-236 as described with regard to FIG. 2. In some examples, the available bandwidth between a client device, such as first client device 130, and the processing circuitry 120 can be maximized by intelligently selecting the bitrate variants to maximize the available bandwidth. For example, if a network bandwidth is 5 Mbps and the bitrate variants for each of the audio, video and advertisement data are 0.5 Mbps, 1 Mbps or 2 Mbps variants, choosing a 0.5 Mbps variant for each of the audio, video and advertisement data would not be utilizing the available bandwidth. The sum total of the variants in that example is 1.5 Mbps, leaving 3.5 Mbps bandwidth available that is not being utilized.

Therefore, in some examples, step 404 also includes intelligently selecting a configuration of the plurality of alternative variants of the multimedia content to maximize the available bandwidth. Returning to the previous example, it would be possible to maximize the available bandwidth of 5 Mbps by choosing two bitrate variants of 2 Mbps and one bitrate variant of 1 Mbps. In some examples, based on the content of the audio, video and advertisement data, a different priority may be assigned to the audio playlist 210, video playlist 220 and advertisement playlist 230. For whichever playlist has a lowest priority, for example, advertisement playlist 230, the advertisement bitrate variant will be the lowest value bitrate variant of the selected bitrate variants. It should be understood that any of the audio playlist 210, video playlist 220, or advertisement playlist 230 may have a relative higher priority or lower priority, and this example is not limiting to the process described.

At step 406, a first stream of multimedia content is streamed, similar to step 304 of FIG. 3. In some examples, the first stream of multimedia content is encoded at a first maximum bitrate and/or a first resolution. For example, the request may be a request for a next segment of an adaptive bitrate stream, and therefore the first stream of multimedia content is at a first maximum bitrate (or resolution) based on a first network bandwidth.

At step 408, a second request to stream multimedia content is received. Similar to step 306 from FIG. 3, for example, the request may be a request for a second segment of an adaptive bitrate stream. The second request to stream multimedia content may also comprise a second network bandwidth at the time of the second request, different from the first network bandwidth.

At step 410, a different one of the plurality of alternative variants of the multimedia content is selected. In some examples, the network bandwidth may decrease or increase between the first and second request to stream multimedia content. For example, if the network bandwidth increased from 5 Mbps to 6 Mbps, using the same exemplar bitrate variant sizes from step 404 above, there is no longer a need for 2 bitrate variants at 2 Mbps and one bitrate variant at 1 Mbps. Rather, all three bitrate variants can be selected to be 2 Mbps to better maximize the newly increased available bandwidth.

Moreover, the available bandwidth may decrease. For example, if the available bandwidth decreases from 5 Mbps to 4 Mbps, then each of the bitrate variants can be chosen to maximize the decreased bandwidth.

At step 412, a second stream of multimedia content is streamed. In some examples, the second stream of multimedia content is encoded at a second maximum bitrate and/or a second resolution. The second stream may therefore be a higher bitrate than the first stream, or vice versa, depending on the network bandwidth at the time of the second request.

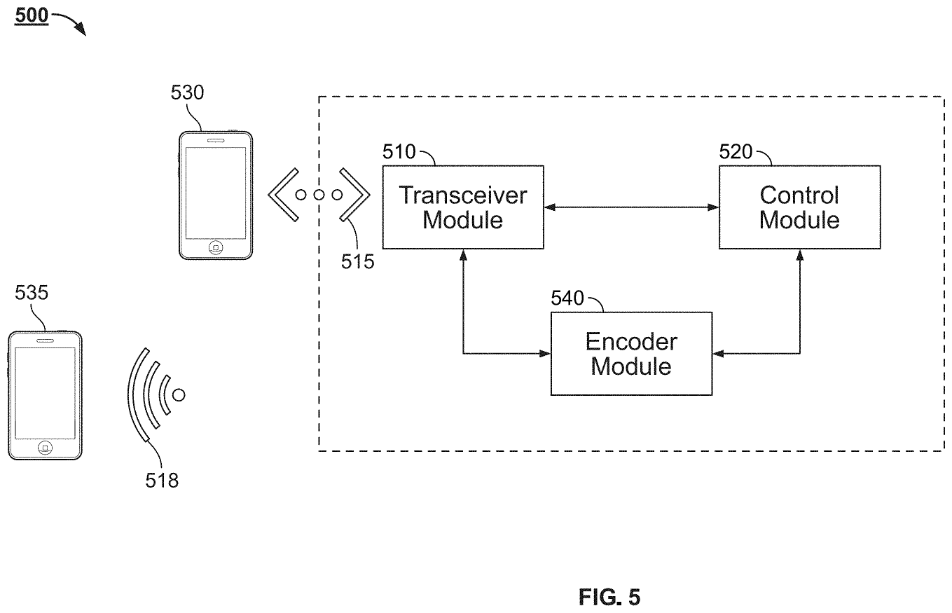

FIG. 5 illustrates an exemplary media transmission system 500 comprising a transceiver module 510, a control module 520, and an encoder module 540. The media transmission system communicates with at least one client device 530. The transceiver module 510 receives a device parameter from a first client device 530 and transmits multimedia content to the first client device 530. The multimedia content may be stored on a multimedia content storage 110, as described with reference to FIG. 1.

In some examples, the transceiver module communicates with first client device 530 via communication link 515. The communication link 515 between the transceiver module 510 and the first client device 530 may comprise a physical connection, facilitated by an input port such as a 3.5 mm jack, RCA jack, USB port, ethernet port, or any other suitable connection for communicating over a wired connection, or may comprise a wireless connection via BLUETOOTH, Wi-Fi, WiMAX, Zigbee, GSM, UTMS, CDMA, TDMA, 3G, 4G, 4G LTE, 5G or other wireless transmission as described by the relevant 802.11 wireless communication protocols.

In some examples, the control module 520 is coupled to the transceiver module 510. The control module is adapted to select one of at least two modes of operation, for example, a first mode of operation and a second mode of operation, wherein the control module 520 selects the mode of operation based on the device parameter received from the first client device 530. The device parameter may be an indication of the available device network bandwidth in the communication link 515, such as a bitrate bandwidth. Accordingly, the control module 520 may select a mode of operation that is better suited to a high-bandwidth communication link 515 or a relatively low-bandwidth communication link 515.

In some examples, the encoder module 540 is coupled to the transceiver module 510 and the control module 520. The encoder module is adapted to encode the multimedia content based on the device parameter and mode of operation selected by the control module 520. For example, if the device parameter is an indication of the device network bandwidth available in communication link 515, the encoder will encode the multimedia content according to the mode of operation selected so that it is suitable for the available device network bandwidth in the communication link 515.

In some examples, the multimedia content is the master playlist 200 as described with reference to FIG. 2, i.e., the multimedia content comprises audio, video and advertisement data. The audio, video and advertisement data are each one of the bitrate variants 212-216, 222-226, 232-236 as described by the audio playlist 210, video playlist 220, and advertisement playlist 230, respectively. Therefore, in some examples, the mode of operation corresponds to a different combination of the bitrate variants from the audio playlist 210, video playlist 220, and advertisement playlist 230.

In some embodiments, the media transmission system 500 may also communicate with a second client device 535 via communication link 518. In some examples, communication link 518 comprises a physical connection, facilitated by an input port such as a 3.5 mm jack, RCA jack, USB port, ethernet port, or any other suitable connection for communicating over a wired connection, or may comprise a wireless connection via BLUETOOTH, Wi-Fi, WiMAX, Zigbee, GSM, UTMS, CDMA, TDMA, 3G, 4G, 4G LTE, 5G or other wireless transmission as described by the relevant 802.11 wireless communication protocols. In some examples, communication link 518 is the same communication link 515 between the first client device 530 and the transceiver module 510.

In some examples, the communication link 518 is between the first client device 530 and the second client device 535. In some examples, the first device 530 transmit a portion of the master playlist 200 to the second client device 535. For example, the second device 535 may receive the advertisement playlist 230 first client device 530. In this way, the user of the first and second devices can consume the audio, video and advertisement data on separate devices in any combination. For example, the user may consume the audio and video data on the first client device 530 and the advertisement data on the second client device 535, or vice versa.

The embodiments herein may also apply to a video platform utilizing adaptive video stream technologies and providing advertisements to a user. For example, in some cases, the user is shown a plurality of advertisements to choose from when an advertisement is to be shown to the user. In some examples of the present disclosure, at least the first segment of a plurality of advertisements can be requested by the first client device 530. In this way, there is a seamless transition to the advertisement without delay. Similar to the way the current MPEG-DASH standard describes loading the first or more segments of a video in a lower-quality bitrate, some examples also do the same for the plurality of advertisements shown to a user.

In some examples, the user of a video platform may have an advertisement blocker installed, which prevents the advertisement from being shown to the user. In such examples, the video platform provider loses revenue, as often revenue is generated by how many impressions an advertisement has, i.e., how many times a certain advertisement is viewed. According to embodiments of the present disclosure, such as those described with reference to FIGS. 1-5, such advertisement blockers would be ineffective. Typically, an advertisement is gathered by a GET request sent to an HTTP server, which is recognized by an advertisement blocker and prevented from buffering. In the present disclosure, the advertisement playlist 230 is a part of the master playlist 200 (or manifest) so the advertisement segments are downloaded along with the audio and video segments, as described with reference to FIG. 2. Therefore, if an advertisement blocker was to block the advertisement segment of the present disclosure, the video and audio data would also be blocked. In this way, the user would opt not to use the advertisement blocker, and instead would consume the advertisement data from the master playlist 200 in desirable way, as described herein.

FIG. 6 is a block diagram representing devices, components of each device, and data flow therebetween for an adaptive video streaming system, in accordance with some embodiments of the disclosure. System 600 is shown to include a client device 618, a server 602 and a communication network 614. It is understood that while a single instance of a component may be shown and described relative to FIG. 6, additional instances of the component may be employed. For example, server 602 may include, or may be incorporated in, more than one server. Similarly, communication network 614 may include, or may be incorporated in, more than one communication network. Server 602 is shown communicatively coupled to client device 618 through communication network 614. While not shown in FIG. 6, server 602 may be directly communicatively coupled to client device 618, for example, in a system absent or bypassing communication network 614.

Communication network 614 may comprise one or more network systems, such as, without limitation, an internet, LAN, WIFI or other network systems suitable for audio processing applications. In some embodiments, system 600 excludes server 602, and functionality that would otherwise be implemented by server 602 is instead implemented by other components of system 600, such as one or more components of communication network 614. In still other embodiments, server 602 works in conjunction with one or more components of communication network 614 to implement certain functionality described herein in a distributed or cooperative manner. Similarly, in some embodiments, system 600 excludes client device 618, and functionality that would otherwise be implemented by client device 618 is instead implemented by other components of system 600, such as one or more components of communication network 614 or server 602 or a combination. In still other embodiments, client device 618 works in conjunction with one or more components of communication network 614 or server 602 to implement certain functionality described herein in a distributed or cooperative manner.

Client device 618 includes control circuitry 628, display 634 and input output circuitry 616. Control circuitry 628 in turn includes transceiver circuitry 662, storage 638 and processing circuitry 640. In some embodiments, client device 618 or control circuitry 628 may be configured as client device 130 or 530 of FIGS. 1 and 5.

Server 602 includes control circuitry 620 and storage 624. Each of storages 624 and 638 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 624, 638 may be used to store various types of content, media data, and or other types of data (e.g., they can be used to store multimedia content such as audio, video and advertisement data). Non-volatile memory may also be used (e.g., to launch a boot-up routine and other instructions). Cloud-based storage may be used to supplement storages 624, 638 or instead of storages 624, 638. In some embodiments, the pre-encoded or encoded multimedia content, in accordance with the present disclosure, may be stored on one or more of storages 624, 638.

In some embodiments, control circuitry 620 and/or 628 executes instructions for an application stored on memory (e.g., storage 624 and/or storage 638). Specifically, control circuitry 620 and/or 628 may be instructed by the application to perform the functions discussed herein. In some implementations, any action performed by control circuitry 620 and/or 628 may be based on instructions received from the application. For example, the application may be implemented as software or a set of executable instructions that may be stored on storage 624 and/or 638 and executed by control circuitry 620 and/or 628. In some embodiments, the application may be a client/server application where only a client application resides on client device 618, and a server application resides on server 602.

The application may be implemented using any suitable architecture. For example, it may be a stand-alone application wholly implemented on client device 618. In such an approach, instructions for the application are stored locally (e.g., in storage 638), and data for use by the application is downloaded on a periodic basis (e.g., from an out-of-band feed, from an internet resource, or using another suitable approach). Control circuitry 628 may retrieve instructions for the application from storage 638 and process the instructions to perform the functionality described herein. Based on the processed instructions, control circuitry 628 may determine a type of action to perform in response to input received from input/output path (or input output circuitry) 616 or from communication network 614. For example, in response to a network bandwidth maximum, control circuitry 628 may perform the steps of processes relative to various embodiments discussed herein.

In client/server-based embodiments, control circuitry 628 may include communication circuitry suitable for communicating with an application server (e.g., server 602) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 614). In another example of a client/server-based application, control circuitry 628 runs a web browser that interprets web pages provided by a remote server (e.g., server 602). For example, the remote server may store the instructions for the application in a storage device. The remote server may process the stored instructions using circuitry (e.g., control circuitry 628) and/or generate displays. Client device 618 may receive the displays generated by the remote server and may display the content of the displays locally via display 634. This way, the processing of the instructions is performed remotely (e.g., by server 602) while the resulting displays, such as the display windows described elsewhere herein, are provided locally on client device 618. Client device 618 may receive inputs from the user via input circuitry 616 and transmit those inputs to the remote server for processing and generating the corresponding displays. Alternatively, client device 618 may receive inputs from the user via input circuitry 616 and process and display the received inputs locally, by control circuitry 628 and display 634, respectively.

Server 602 and client device 618 may transmit and receive content and data such as media content via communication network 614. For example, server 602 may be a media content provider, and client device 618 may be a smart television configured to download or stream media content, such as a YouTube video, from server 602. Control circuitry 620, 628 may send and receive commands, requests, and other suitable data through communication network 614 using transceiver circuitry 660, 662, respectively. Control circuitry 620, 628 may communicate directly with each other using transceiver circuitry 660, 662, respectively, avoiding communication network 614.

It is understood that client device 618 is not limited to the embodiments and methods shown and described herein. In nonlimiting examples, client device 618 may be a television, a Smart TV, a set-top box, an integrated receiver decoder (TRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media centre, a handheld computer, a stationary telephone, a personal digital assistant (PDA), a mobile telephone, a portable video player, a portable music player, a portable gaming machine, a smartphone, or any other device, client equipment, or wireless device, and/or combination of the same capable of suitably displaying and manipulating media content.

Control circuitry 620 and/or 618 may be based on any suitable processing circuitry such as processing circuitry 626 and/or 640, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 620 and/or control circuitry 618 are configured to implement a media content operation system, such as systems, or parts thereof, that perform various media content manipulation processes described herein.

Client device 618 receives a user input 604 at input circuitry 616. For example, client device 618 may receive a user input like a user swipe or user touch, as previously discussed. In some embodiments, client device 618 is a media device (or player), with the capability to access media content. It is understood that client device 618 is not limited to the embodiments and methods shown and described herein. In nonlimiting examples, client device 618 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media centre, a handheld computer, a stationary telephone, a personal digital assistant (PDA), a mobile telephone, a portable video player, a portable music player, a portable gaming machine, a smartphone, or any other television equipment, computing equipment, or wireless device, and/or combination of the same.

User input 604 may be received from a user selection-capturing interface that is separate from device 618, such as a remote-control device, trackpad or any other suitable user movement sensitive or capture devices, or as part of device 618, such as a touchscreen of display 634. Transmission of user input 604 to client device 618 may be accomplished using a wired connection, such as an audio cable, USB cable, ethernet cable or the like attached to a corresponding input port at a local device, or may be accomplished using a wireless connection, such as BLUETOOTH, Wi-Fi, WiMAX, ZIGBEE, GSM, UTMS, CDMA, TDMA, 3G, 4G, 4G LTE, or any other suitable wireless transmission protocol. Input circuitry 616 may comprise a physical input port such as a 3.5 mm audio jack, RCA audio jack, USB port, ethernet port, or any other suitable connection for receiving audio over a wired connection, or may comprise a wireless receiver configured to receive data via BLUETOOTH, Wi-Fi, WiMAX, ZIGBEE, GSM, UTMS, CDMA, TDMA, 3G, 4G, 4G LTE, or other wireless transmission protocols.

Processing circuitry 640 may receive input 604 from input circuit 616. Processing circuitry 640 may convert or translate the received user input 604 that may be in the form of gestures or movement to digital signals. In some embodiments, input circuit 616 performs the translation to digital signals. In some embodiments, processing circuitry 640 (or processing circuitry 626, as the case may be) carries out disclosed processes and methods.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods. In this specification, the following terms may be understood in view of the below explanations:

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of streaming adaptive video content, the method comprising:
receiving a first request to stream multimedia content stored on a multimedia content storage, wherein:
the multimedia content is a master playlist comprising audio, video and advertisement data; and
each of the audio, video and advertisement data comprises a set of alternative variants;
streaming a first stream of multimedia content, wherein the first stream of multimedia content is one of the set of alternative variants of the multimedia content;
receiving a second request to stream multimedia content stored on the multimedia content storage;
streaming a second stream of multimedia content, wherein the second stream of multimedia content is a different one of the set of alternative variants of the multimedia content.

2. The method of claim 1, wherein the alternative variants comprise a plurality of bitrate variants.

3. The method of claim 2, further comprising selecting, in response to the first request, one of the plurality of bitrate variants for each of the audio, video and advertisement data.

4. The method of claim 1, further comprising encoding the first stream of multimedia content at a first maximum bitrate.

5. The method of claim 1, further comprising encoding the first stream of multimedia content at a first resolution.

6. The method of claim 1, further comprising encoding the second stream of multimedia content at a second maximum bitrate.

7. The method of claim 1, further comprising encoding the second stream of multimedia content at a second resolution.

8. The method of claim 1, further comprising encoding the multimedia content is using an adaptive video streaming compatible codec.

9. The method of claim 1, wherein receiving the first request to stream multimedia content received from a first client device.

10. The method of claim 9, wherein the audio, video and advertisement data is consumed by a user at the same time on the first client device.

11. The method of claim 10, further comprising transmitting the advertisement data to a second client device.

12. The method of claim 11, wherein the advertisement data is consumed on the second client device and the audio and video data is consumed on the first client device, by a user, concurrently.

13. A media server, comprising:
multimedia content storage; and
processing circuitry, wherein the processing circuitry is configured to:
receive a first request to stream multimedia content stored on the multimedia content storage, wherein:
the multimedia content is a master playlist comprising audio, video and advertisement data; and
each of the audio, video and advertisement data comprises a set of alternative variants;
stream a first stream of multimedia content, wherein the first stream of multimedia content is one of the set of alternative variants of the multimedia content;
receive a second request to stream multimedia content stored on the multimedia content storage;
stream a second stream of multimedia content, wherein the second stream of multimedia content is a different set of alternative variants of the multimedia content.

14. The media server of claim 13, wherein the alternative variants comprise a plurality of bitrate variants.

15. The media server of claim 13, wherein the first stream of multimedia content is encoded at a first maximum bitrate.

16. The media server of claim 13, wherein the first stream of multimedia content is encoded at a first resolution.

17. The media server of claim 13, wherein the second stream of multimedia content is encoded at a second maximum bitrate.

18. The media server of claim 13, wherein the second stream of multimedia content is encoded at a second resolution.

19. The media server of claim 13, wherein the multimedia content is encoded using an adaptive video streaming compatible codec.

20. The media server of claim 13, wherein the first request to stream multimedia content is received from a first client device.

21.-54. (canceled)
